(19) United States
(12) Patent Application Publication
(10) Pub. No.: US 2007/0188582 A1
(43) Pub. Date: Aug. 16, 2007

(54) Electrostatic actuator with charge control surface

(75) Inventors: Cleopatra Cabuz, Edina, MN (US); Eugen I. Cabuz, Edina, MN (US); Tzu-Yu Wang, Maple Grove, MN (US); Chunbo Zhang, Plymouth, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Honeywell International Inc.

(21) Appl. No.: 11/354,683

(22) Filed: Feb. 15, 2006

(51) Int. Cl. B41J 2/41

(52) U.S. Cl. 347/112

(57) ABSTRACT

An electrostatic actuator includes a body having a chamber therein, a first electrode secured to the chamber, and a diaphragm mounted to the body. The diaphragm includes a mounting surface portion secured to the body, and a dynamic surface portion for movement within the chamber. The electrostatic actuator also includes a second electrode secured relative to the diaphragm. In some embodiments, the first electrode includes a void therein. In other embodiments, the second electrode includes a void therein. In still other embodiments, both the first and the second electrode include voids therein.

### FIELD OF THE INVENTION

The present invention generally relates to electro-pneumatic transducers, and more particularly, to electrostatic actuators.

### BACKGROUND

Many industrial, commercial, aerospace, military and other applications require accurate and controllable displacement actuators. Electrostatic actuators operate using electrostatic forces. Electrostatic actuators have a non-linear operation. In other words, for a given voltage differential placed across the electrostatic actuator, the displacement is non-linear. More specifically, the non-linear operation is due to a snapping point at which the displacing elements makes a sudden and sharp change in location versus the applied voltage.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1A is a schematic view of a system 100, that includes an electrostatic actuator, according to an example embodiment.

FIG. 1B is a top view of the diaphragm 120 of FIG. 1A, according to an example embodiment.

FIG. 2 is a schematic view of a system 200, that includes an electrostatic actuator, according to an example embodiment.

FIG. 3 is a side view of a portion of an electrostatic actuator, according to an example embodiment.

FIG. 4 is a bottom view of an electrostatic actuator along line 4-4 in FIG. 3, according to an example embodiment.

FIG. 5 is a side view of a portion of an electrostatic actuator, according to an example embodiment.

FIG. 6 is a bottom view of an electrostatic actuator along line 6-6 in FIG. 5, according to an example embodiment.

FIG. 7 is a side view of a portion of an electrostatic actuator, according to an example embodiment.

FIG. 8 is a bottom view of an electrostatic actuator along line 8-8 in FIG. 7, according to an example embodiment.

FIG. 9 is a graph of displacement of the dynamic portion of a diaphragm of the electrostatic actuator verses the voltage differential for several electrostatic actuators.

FIG. 10 is a side view of a portion of an electrostatic actuator, according to an example embodiment.

FIG. 11 is a bottom view of an electrostatic actuator along line 11-11 in FIG. 10, according to an example embodiment.

FIG. 12 is a graph of displacement of the diaphragm of the electrostatic actuator verses the voltage differential for the electrostatic actuator shown in FIGS. 10 and 11, according to an example embodiment.

FIG. 13 is a side view of an electrostatic actuator 1300, according to an example embodiment.

FIG. 14 is a cross sectional view along line 14-14 from FIG. 15 of a body that includes a conically-shaped chamber, according to an example embodiment.

FIG. 15 is a view into the conically shaped chamber of the body, according to an example embodiment.

FIG. 16 is a view into the conically shaped chamber of the body, according to an example embodiment.

FIG. 17 is a view into the conically shaped chamber of the body, according to an example embodiment.

FIG. 18 is a view into the conically shaped chamber of the body, according to an example embodiment.

FIG. 19 is a side view of an electrostatic actuator 1900 that includes a diaphragm, according to an example embodiment.

FIG. 20 is a view along line 20-20 from FIG. 19 of the body that includes the conically-shaped chamber, according to an example embodiment. (out of alignment between first and second electrode)

### DESCRIPTION OF PREFERRED EMBODIMENTS

In the following detailed description of the preferred embodiments, reference is made to the accompanying drawings that form a part hereof, and in which are shown by way of illustration specific embodiments in which some embodiments of the invention may be practiced. It is understood that other embodiments may be utilized and structural changes may be made without departing from the scope of the present invention.

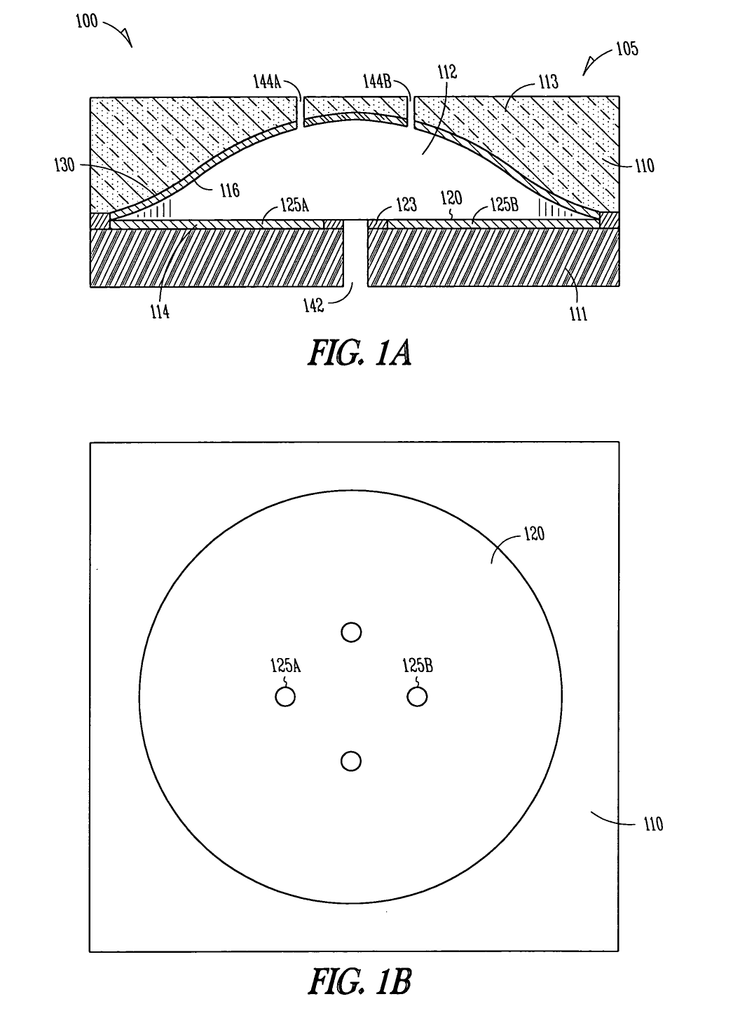

FIG. 1A is a schematic view of a system 100, that includes an electrostatic actuator, according to an example embodiment. FIG. 1 is a cross-sectional side view of a normally closed valve, illustrative of one example embodiment. The valve is generally shown at 105, and has a body 110 with a first opposing wall 114 and a second opposing wall 116 that define a valve chamber 112. In the example embodiment, a first port 142 (e.g. inlet port) extends into the valve chamber 112 through the first opposing wall 114. One or more second ports (e.g. outlet ports), such as ports 144a and 144b, extend into the valve chamber 112 through the second opposing wall 116.

A diaphragm 120 is mounted within the chamber 112. In some embodiments, this may be accomplished by sandwiching the diaphragm 120 between an upper body portion 113 and a lower body portion 111. In the illustrative embodiment, the diaphragm 120 extends along the first opposing wall 114 in the un-activated state. In some embodiments, the diaphragm 120 is spaced from the first opposing wall 114 except along a valve seat 123, which extends around the first port 142. To actuate the diaphragm 120, the diaphragm 20 may include one or more electrodes, which may extend to at least near the edges of the chamber 112. In some embodiments, the one or more electrodes of the diaphragm are surrounded or encapsulated in a dielectric material or layer.

In the example embodiment shown in FIG. 1, the second opposing wall 116 includes one or more stationary electrodes, such as electrode 130. The second opposing wall 116 and the diaphragm 120 may be configured so that, in the un-activated state, the separation distance between the stationary electrode 130 and the electrode of the diaphragm 120 is smaller near the edges of the chamber 112. In other embodiments, however, the separation distance between the stationary electrode 130 and the electrode of the diaphragm 120 may be smaller in the center or any other area of the chamber 112, as desired. By providing a region in the chamber 112 that has a smaller separation distance, the diaphragm 120 may be drawn toward the second opposing wall 116 in a rolling action when a voltage is applied between the electrode of the diaphragm 120 and the stationary electrode and 130.

For purposes of illustration, the first opposing wall 114 is shown generally flat. However, the first opposing wall 114 may assume other shapes, depending upon the application. For example, the first opposing wall 114 may have different regions that are recessed or protrude against the diaphragm 120 in order to, for example, reduce damage to the diaphragm 120 after continued activation. Other shapes may also be used, including curved shapes, for example. Although the second opposing wall 116 is shown to be generally curved, other shapes may be used, depending on the application.

Body 110 can be made from any suitable semi-rigid or rigid material, such as plastic, ceramic, silicon, and the like. In one illustrative embodiment, the body 110 is constructed by molding a high temperature plastic such as ULTEM™ (available from General Electric Company, Pittsfield, Mass.), CELAZOLE™ (available from Hoechst-Celanese Corporation, Summit, N.J.), KETRON™ (available from Polymer Corporation, Reading, Pa.), or some other suitable material. In some embodiments, the material used for the diaphragm 120 may have elastic, resilient, flexible or other elastomeric properties. In other embodiments, the diaphragm 120 is made from a generally compliant material. In one embodiment, the diaphragm 120 is made from a polymer such as KAPTON (available from E. I. du Pont de Nemours & Co., Wilmington, Del.), KALADEX.(available from ICI Films, Wilmington, Del.), MYLAR™ (available from E. I. du Pont de Nemours & Co., Wilmington, Del.), or any other suitable material.

The one or more electrodes on the diaphragm 120 may be provided by patterning a conductive coating on the diaphragm 120. For example, the one or more electrodes may be formed by printing, plating or EB deposition of metal. In some cases, the electrode layer may be patterned using a dry film resist. The same or similar techniques may be used to provide the electrode 130 on the second opposing wall 116 of the body 110. Rather than providing a separate electrode layer, it is contemplated that the diaphragm 120 or the second opposing wall 116 may be made conductive so as to function as an electrode, if desired. A dielectric, such as a low temperature organic and inorganic dielectric, may be used as an insulator between the fixed and dynamic electrodes. The dielectric may be coated over the electrode on the diaphragm 120, the electrode 130 on the second opposing wall 116, or both, as desired.

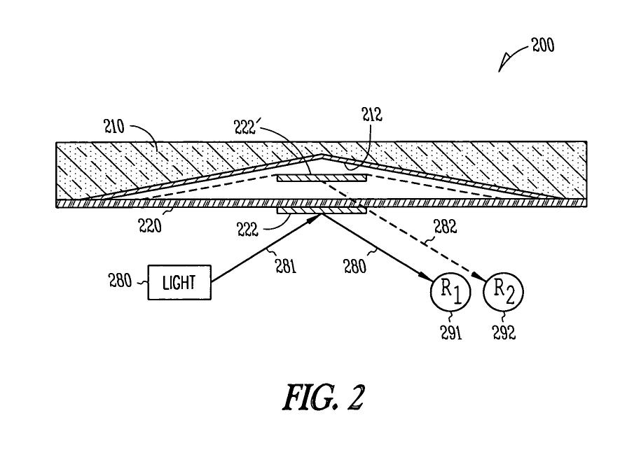

As shown in FIG. 1A, the diaphragm 20 may have at least one opening (openings 25a and 25b) that is laterally offset from the first port 42 when the diaphragm 20 is in a first position adjacent the first opposing wall 14. FIG. 2 is a cross-sectional top view of the illustrative normally closed valve of FIG. 1A.

FIG. 1B is a top view of the diaphragm 120 of FIG. 1A, according to an example embodiment. As can be seen in FIG. 1B, the diaphragm 120 may include one or more openings 125a and 125b. The openings 125a and 125b in the diaphragm 120 may be configured so that the diaphragm 20 covers or otherwise restrict fluid flow through the first port 142 and into the chamber 112 when the diaphragm 120 is adjacent the first opposing wall 114. When the diaphragm is electrostatically actuated and pulled toward the second opposing wall 116, the diaphragm 120 moves away and uncovers the first port 42. This allows fluid (a liquid or a gas) to flow between the first port 142 and the second port or ports 144a and 144b via the one or more openings 125a and 125b in the diaphragm 120.

In some embodiments, the diaphragm 120 may become elastically deformed when electrostatically pulled toward the second opposing wall 116. When so provided, the diaphragm 120 may return to the un-activated first position adjacent the first opposing wall 114 under elastic restoring forces when the activation voltage is removed or reduced between the electrode of the diaphragm 120 and the electrode 130 of the second opposing wall 16. In this illustrative embodiment, the diaphragm 120 may only need to be electrostatically actuated in one direction, with the elastic restoring forces returning the diaphragm 120 to the original un-actuated state.

FIG. 2 is a schematic view of a system 200 that also includes an electrostatic actuator, according to an example embodiment. The system 200 includes a body 210 having a cavity or chamber 212. The chamber 212 is conically shaped in this particular example embodiment. The diaphragm 220 includes a reflector 222. The reflector 222 can be made of any reflective material including aluminum, silver, copper or the like. The reflector 222 is deposited or sputtered on to the diaphragm 220 and provides a reflective surface for light. The system 200 also includes a light source 280 which produces a beam or ray of light 281.

As shown in FIG. 2, light source 281 reflects off of the reflector 222 and produces a reflected ray 280 which is received at a receiver 291. As also shown in FIG. 2, the diaphragm 220 is moved to a second position, as depicted by the dotted lines. When the diaphragm 220 moves to the second position, the reflector also moves to a second position. The reflector in the second position carries the reference numeral 222′. The light ray 281 produced by the light source 280 again reflects off the reflector in its position 222′ and produces a reflected light ray 282 which is received at receiver 292. Thus, in the second application, the diaphragm 222 is moved with respect to the body 210 and within the chamber 212 to direct light from light source 280 to one of a plurality of receivers 291, 292. It should be noted that although only two receivers are shown in this particular system 200, there could be many more receivers. The diaphragm 220 must be accurately moved with respect to the body 210 and with respect to the light source 280 so that light is received accurately at the light receivers 291 and 292. One application of this electrostatic actuator is for an optical switch or for use as an optical switching apparatus.

It should be noted that it is critical to have accurate displacement of the diaphragm 120, 220 with respect to the body 110, 210 of the actuator for use in various applications. Shown in FIGS. 1 and 2 above are two applications. It should be understood also that there are many more applications that can be utilize diaphragms whose displacement can be precisely controlled. Such applications include pumps, modulation valves, optical switches, and the like.

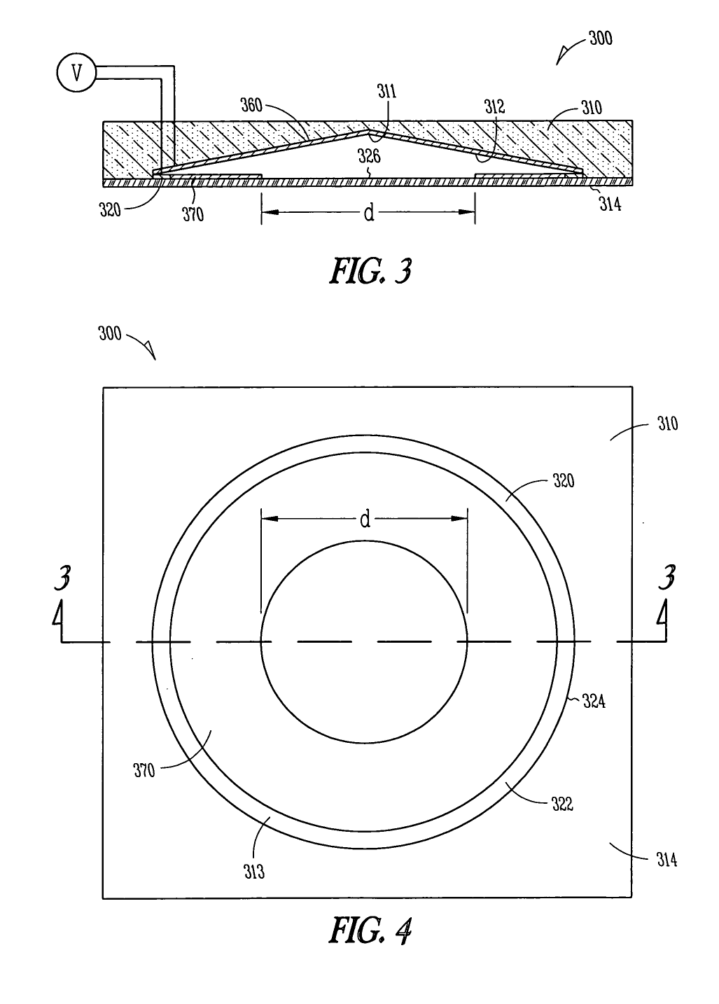

FIG. 3 is a side view of a portion of an electrostatic actuator 300 along line 3-3 in FIG. 4, according to an example embodiment. FIG. 4 is a bottom view of the electrostatic actuator 300, according to an example embodiment. Now referring both to FIGS. 3 and 4, the electrostatic actuator 300 will be further detailed. Electrostatic actuator 300 includes a body 310 that has a chamber 312. As shown in FIGS. 3 and 4, the chamber 312 is substantially conical. The chamber has substantially straight sidewalls which are covered with a conductive material to form a first electrode 360. The first electrode can also be termed as the fixed electrode. Mounted or attached to the body 310 of the actuator 300 is a diaphragm 320. The diaphragm is made of a thin sheet of material such as polyimide. The sheet or film of polyimide is available under the trademark name Kapton®, which is available from DuPont High Performance Materials of Circleville, Ohio. The diaphragm has a mounting surface portion 322. The mounting surface portion 322 is mounted or attached to a bottom flat surface 314 of the body 310. More specifically, the diaphragm 320 is attached or mounted using the mounting surface 322 on the flat surface 314 about the periphery of the chamber 312. The chamber, or more specifically the periphery as a chamber, is depicted by dotted line 313 in FIG. 4.

The diaphragm 320 also includes an electrode 370, which has been deposited on the surface of the film or sheet comprising the diaphragm 320. The major portion of the electrode 370 is positioned on the dynamic surface 324 of the diaphragm 320. In other words, a major portion of the electrode 370 moves with the dynamic surface 324 of the diaphragm 320. Therefore, the electrode 370 is referred to as the dynamic electrode or the second electrode 370. The dynamic electrode or second electrode 370 does not cover the entire dynamic surface 324 of the diaphragm 320. Put another way, the electrode 370 has a void 372 therein. As shown in FIG. 4, the electrode 370 is ring shaped. The void 372 in the ring shaped electrode has a diameter designated by the letter d. As shown in FIGS. 3 and 4, the void 372 is circular. The void 372 is centered or substantially centered about the center of the diaphragm 320. The void 372 is also centered about a center 311 of the chamber 312.

In operation, a voltage differential is placed across the first electrode or fixed electrode 360 and across the dynamic electrode or second electrode 370. The difference in charge produces an electrostatic field. As a result, the dynamic electrode 370 is attracted to the fixed or first electrode 360. By providing a void 372 in the electrode 370, the amount of attractive force is reduced so that the dynamic portion or dynamic surface 324 of the diaphragm 320 can be controlled in a more linear fashion when compared to a dynamic electrode that completely covers a diaphragm.

The diaphragm 320 and the electrode 370 are covered with an insulative material 326. In some embodiments of the invention, the insulative material 326 is a dielectric material which is deposited or sputtered on to the diaphragm 320 and the electrode 370. The material of the diaphragm is generally opaque such that the electrode is visible through the material of the diaphragm 320 when viewed from the bottom of the electrostatic actuator.

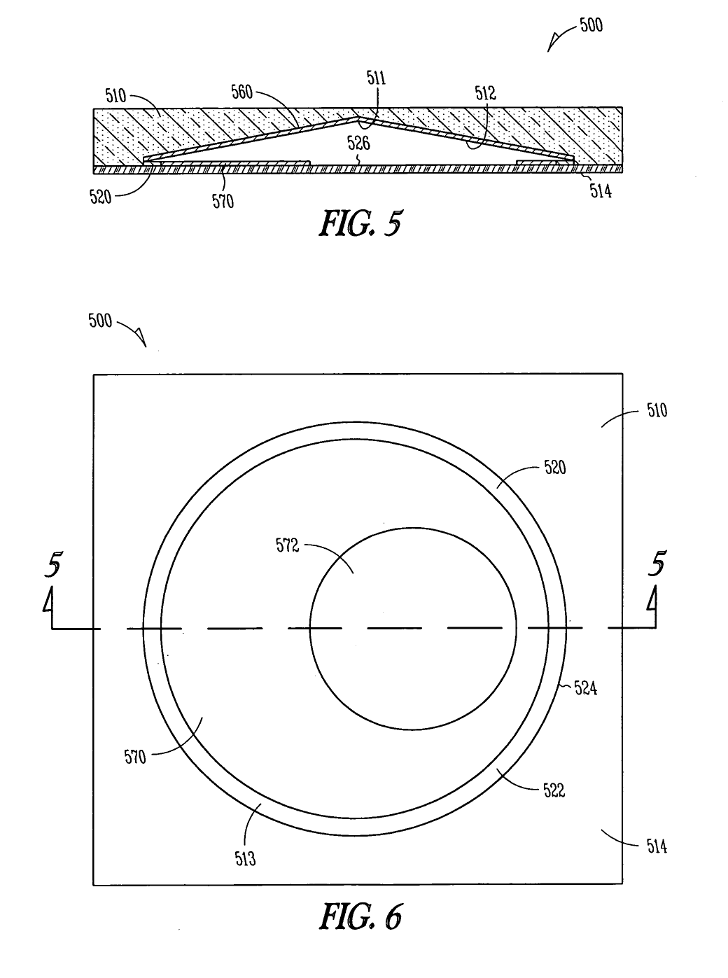

FIG. 5 is a cut away side view of a portion of an electrostatic actuator 500, along line 5-5 in FIG. 6, according to an example embodiment. FIG. 6 is a bottom view of the electrostatic actuator 500, according to an example embodiment. Now referring both to FIGS. 5 and 6, the electrostatic actuator 500 will be further detailed. Electrostatic actuator 500 includes a body 510 that has a chamber 512. As shown in FIGS. 5 and 6, the chamber 512 is substantially conical. The chamber has substantially straight sidewalls which are covered with a conductive material to form a first electrode 560. The first electrode can also be termed as the fixed electrode. Mounted or attached to the body 510 of the actuator 500 is a diaphragm 520. The diaphragm 520 is made of a thin sheet of material such as polyimide. The sheet or film of polyimide is available under the trademark name Kapton®, which is available from DuPont High Performance Materials of Circleville, Ohio. The diaphragm has a mounting surface portion 522. The mounting surface portion 522 is mounted or attached to a bottom flat surface 514 of the body 510. More specifically, the diaphragm 520 is attached or mounted using the mounting surface 522 on the flat surface 514 about the periphery of the chamber 512. The chamber, or more specifically the periphery of the chamber 512, is depicted by dotted line 513 in FIG. 6. The diaphragm 520 also includes an electrode 570, which has been deposited on the surface of the film or sheet comprising the diaphragm 520. The major portion of the electrode 570 is positioned on the dynamic surface 524 of the diaphragm 520. In other words, a major portion of the electrode 570 moves with the dynamic surface 524 of the diaphragm 520. Therefore, the electrode 570 is referred to as the dynamic electrode or the second electrode 570. As shown in FIG. 6, the electrode 570 is circular and has a void 572 therein. The void 572 has a diameter d. The center of the circular void 572 is offset with respect to the center of the circular electrode 570. Therefore, the dynamic electrode or second electrode 570 does not cover the entire dynamic surface 524 of the diaphragm 520. Put another way, the center of the void 572 offset from the center of the circular electrode 570 and offset from a center 511 of the chamber 512.

In operation, a voltage differential is placed across the first electrode or fixed electrode 560 and across the dynamic electrode or second electrode 570. The difference in charge produces an electrostatic field. As a result, the dynamic electrode 570 is attracted to the fixed or first electrode 560. By providing a void 572 in the electrode 670, the amount of attractive force is reduced so that the dynamic portion or dynamic surface 524 of the diaphragm 520 can be controlled in a more linear fashion when compared to a dynamic electrode that completely covers a diaphragm.

The diaphragm 520 and the electrode 570 are covered with an insulative material 526. In some embodiments of the invention, the insulative material 526 is a dielectric material which is deposited or sputtered on to the diaphragm 520 and the electrode 570. The material of the diaphragm is generally opaque such that the electrode is visible through the material of the diaphragm when viewed from the bottom of the electrostatic actuator.

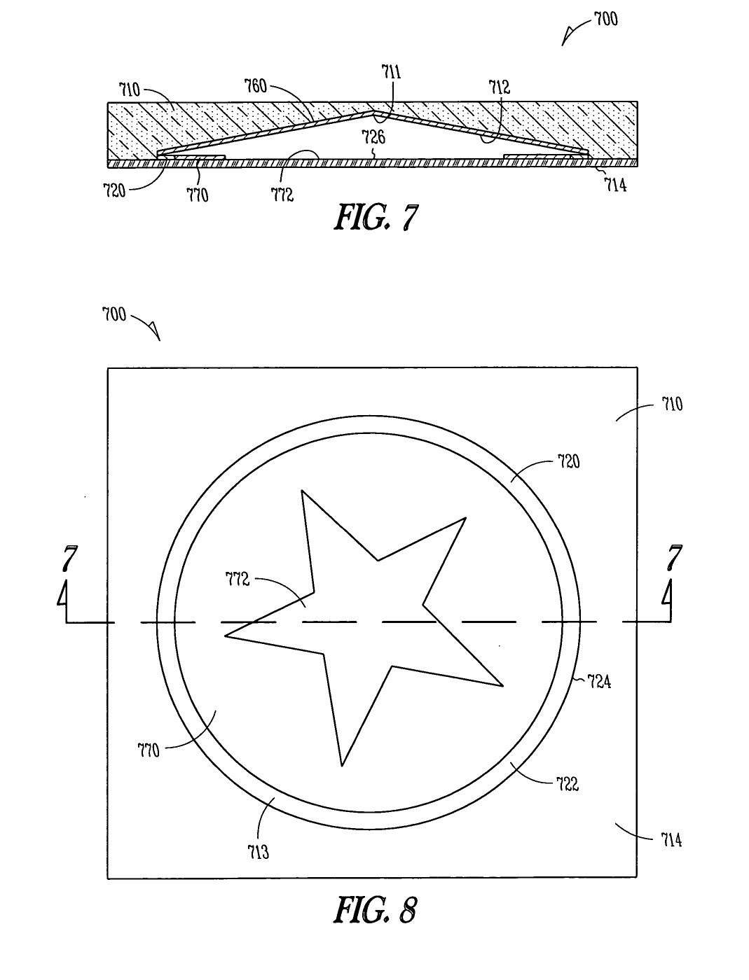

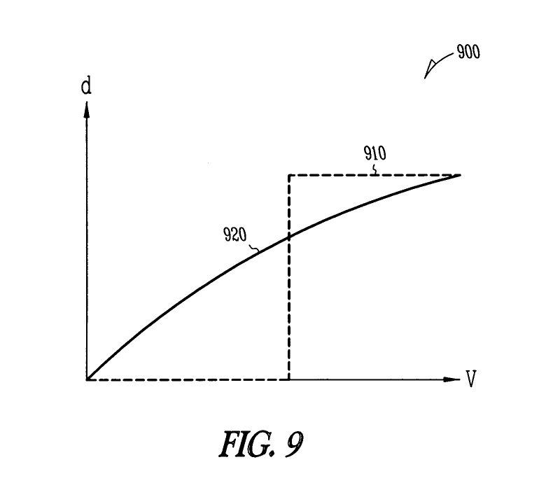

FIG. 7 is a side view of a portion of an electrostatic actuator 700 along line 7-7 in FIG. 8, according to an example embodiment. FIG. 8 is a bottom view of the electrostatic actuator 700, according to an example embodiment. Now referring both to FIGS. 7 and 8, the electrostatic actuator 700 will be further detailed. Electrostatic actuator 700 includes a body 710 that has a chamber 712. As shown in FIGS. 7 and 8, the chamber 712 is substantially conical. The chamber has substantially straight sidewalls which are covered with a conductive material to form a first electrode 760. The first electrode can also be termed as the fixed electrode. Mounted or attached to the body 710 of the actuator 700 is a diaphragm 720. The diaphragm is made of a thin sheet of material such as polyimide. The sheet or film of polyimide is available under the trademark name Kapton®, which is available from DuPont High Performance Materials of Circleville, Ohio. The diaphragm has a mounting surface portion 722. The mounting surface portion 722 is mounted or attached to a bottom flat surface 714 of the body 710. More specifically, the diaphragm 720 is attached or mounted using the mounting surface 722 on the flat surface 714 about the periphery of the chamber 712. The chamber, or more specifically the periphery as a chamber, is depicted by dotted line 713 in FIG. 8. The diaphragm 720 also includes an electrode 770, which has been deposited on the surface of the film or sheet comprising the diaphragm 720. The major portion of the electrode 770 is positioned on the dynamic surface 724 of the diaphragm 720. In other words, a major portion of the electrode 770 moves with the dynamic surface 724 of the diaphragm 720. Therefore, the electrode 770 is referred to as the dynamic electrode or the second electrode 770. As shown in FIG. 8, the electrode 770 includes a star-shaped void. Therefore, the dynamic electrode or second electrode 770 does not cover the entire dynamic surface 724 of the diaphragm 720. The star-shaped void 772 is centered or substantially centered about the center of the diaphragm 720. The star-shaped void 772 is also centered about a center 711 of the chamber 712.

In operation, a voltage differential is placed across the first electrode or fixed electrode 760 and across the dynamic electrode or second electrode 770. The difference in charge produces an electrostatic field. As a result, the dynamic electrode 770 is attracted to the fixed or first electrode 760. By providing the star-shaped void 772 in the electrode 770, the amount of attractive force is reduced so that the dynamic portion or dynamic surface 724 of the diaphragm 720 can be controlled in a more linear fashion when compared to a dynamic electrode that completely covers a diaphragm.

The diaphragm 720 and the electrode 770 are covered with an insulative material 726. In some embodiments of the invention, the insulative material 726 is a dielectric material which is deposited or sputtered on to the diaphragm 720 and the electrode 770. The material of the diaphragm is generally opaque such that the electrode is visible through the material of the diaphragm when viewed from the bottom of the electrostatic actuator.

FIG. 9 is a graph 900 of displacement of the dynamic portion of a diaphragm of electrostatic actuator versus the voltage differential for several different electrostatic actuators. The graph includes a Y axis labeled d for displacement or for distance that the dynamic portion of a diaphragm will move and having a X axis labeled v for voltage which is the voltage differential between a first or fixed electrode and the second or dynamic electrode for a particular actuator. Shown as a dotted line is a plot or curve 910 for an actuator that includes a chamber having a fixed electrode that entirely covers the chamber and having a dynamic electrode that entirely covers the dynamic portion or the moving portion of the diaphragm. This curve 910 shows that this type of electrostatic actuator snaps into position. In other words, at a particular voltage, v, the displacement is total as it moves from 0 to an end position and stays there. Also shown in graph 900 is a second curve 920. The curve 920 is a plot of the displacement verses voltage, v, for one of the example embodiments of an electrostatic actuator having a dynamic electrode 370, 570, 770, which includes a void 372, 572, 772 therein. The curve 920 shows that the displacement versus the difference in voltage is more linear than the curve 910. In other words, for a particular voltage difference, the displacement increases in more of a linear fashion and can be controlled

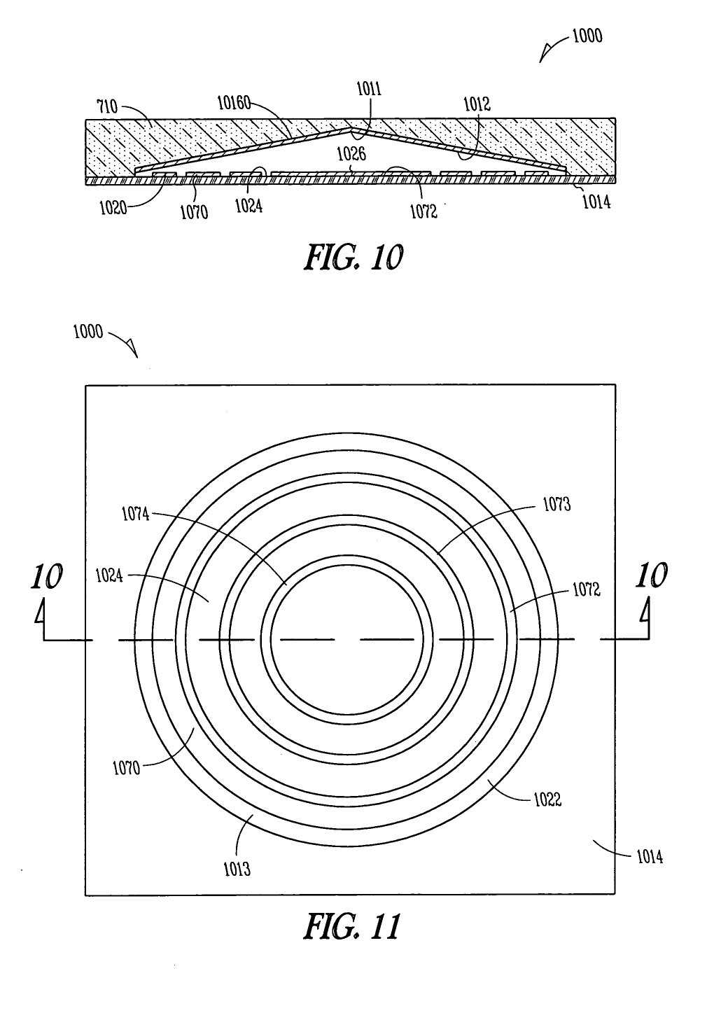

FIG. 10 is a side view of a portion of an electrostatic actuator 1000 along line 10-10 in FIG. 11, according to an example embodiment. FIG. 11 is a bottom view of the electrostatic actuator 1000, according to an example embodiment. Now referring both to FIGS. 10 and 11, the electrostatic actuator 1000 will be further detailed. Electrostatic actuator 1000 includes a body 1010 that has a chamber 1012. As shown in FIGS. 10 and 11, the chamber 1012 is substantially conical. The chamber has substantially straight sidewalls which are covered with a conductive material to form a first electrode 1060. The first electrode can also be termed as the fixed electrode. Mounted or attached to the body 1010 of the actuator 1000 is a diaphragm 1020. The diaphragm is made of a thin sheet of material such as polyimide. The sheet or film of polyimide is available under the trademark name Kapton®, which is available from DuPont High Performance Materials of Circleville, Ohio. The diaphragm has a mounting surface portion 1022. The mounting surface portion 1022 is mounted or attached to a bottom flat surface 1014 of the body 1010. More specifically, the diaphragm 1020 is attached or mounted using the mounting surface 1022 on the flat surface 1014 about the periphery of the chamber 1012. The chamber, or more specifically the periphery as a chamber, is depicted by dotted line 1013 in FIG. 11. The diaphragm 1020 also includes an electrode 1070, which has been deposited on the surface of the film or sheet comprising the diaphragm 1020. The major portion of the electrode 1070 is positioned on a dynamic surface 1024 of the diaphragm 1020. In other words, a major portion of the electrode 1070 moves with the dynamic surface 1024 of the diaphragm 1020. Therefore, the electrode 1070 is referred to as the dynamic electrode or the second electrode 1070. As shown in FIG. 11, the electrode 1070 is shaped as a series of rings and includes ring-shaped voids 1072, 1073, 1074 between the rings. The dynamic electrode or second electrode 1070 does not cover the entire dynamic surface 1024 of the diaphragm 1020. Put another way, the ring-shaped voids 1072, 1073, 1074 in the electrode 1070, results in an dynamic electrode having less than the entire dynamic surface 1024 covered. As shown in FIGS. 10 and 11, the voids 1072, 1073, 1074 are circular. The voids 1072, 1073, 1074 are substantially concentric with a center of the diaphragm 1020. The voids 1072, 1073, 1074 are also substantially concentric with a center 1011 of the chamber 1012.

In operation, a voltage differential is placed across the first electrode or fixed electrode 1060 and across the dynamic electrode or second electrode 1070. The difference in charge produces an electrostatic field. As a result, the dynamic electrode 1070 is attracted to the fixed or first electrode 1060. By providing voids 1072, 1073, 1074 in the electrode 1070, the amount of attractive force is reduced so that the dynamic portion or dynamic surface 1024 of the diaphragm 1020 can be controlled in a step fashion when compared to a dynamic electrode that completely covers a diaphragm.

The diaphragm 1020 and the electrode 1070 are covered with an insulative material 1026. In some embodiments of the invention, the insulative material 1026 is a dielectric material which is deposited or sputtered on to the diaphragm 1020 and the electrode 1070. The material of the diaphragm is generally opaque such that the electrode is visible through the material of the diaphragm when viewed from the bottom of the electrostatic actuator. In one example embodiment, each of the rings of the electrode 1070 have the substantially the same voltage. The rings are electrically connected to one another. In another example embodiment, the rings are placed at different voltage levels.

Rings placed at different voltage levels can also be thought of as multiple electrodes. In other embodiments, multiple electrodes of different shapes can be placed on either the dynamic surface of the actuator. Each of the multiple electrodes can be individually connected to external switching voltage source. The electrodes are actuated in a specific manner to digitally move the displacing element, such as a diaphragm shown, or other displacement element.

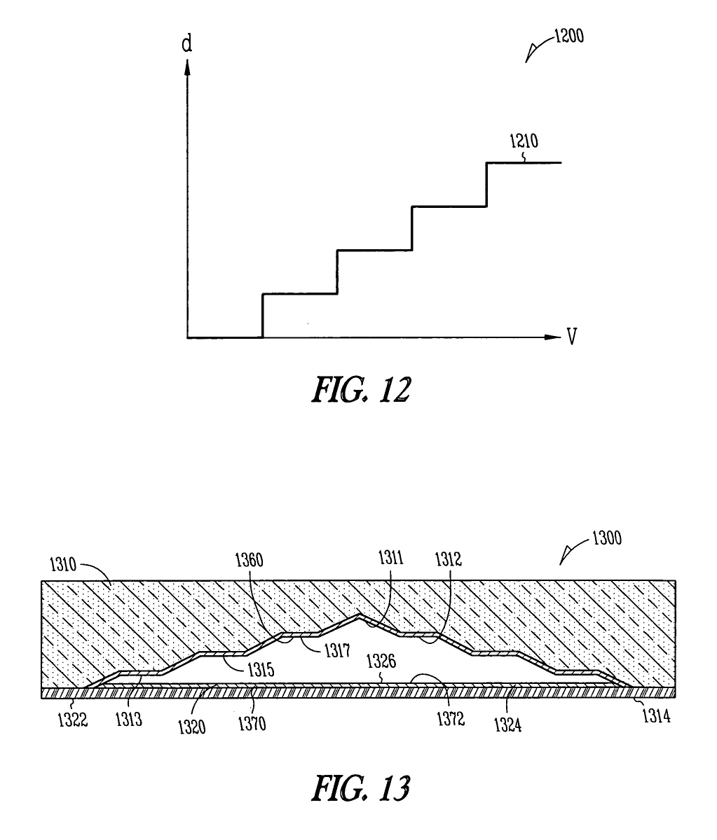

FIG. 12 is a graph of the displacement of a dynamic portion of the diaphragm of the electrostatic actuator 1000 versus the voltage differential for the electrostatic actuator 1000, as shown in FIGS. 10 and 11, according to an example embodiment. The graph carries a reference numeral 1200. The curve 1210 that depicts the displacement for the various differences in voltage for the electrostatic actuator 1000 is actually in the form of a step function, as each of the rings of the electrode 1070 engage the sidewall of the chamber 1012. In other words, the voltage must be increased to a level to attract the initial ring. The voltage level must then be increased further to engage subsequent rings closer to the center of the dynamic portion 1024 of the dynamic electrode 1070 with the first or fixed electrode 1060. Once one of the rings is engaged, the voltage must be increased to a next level where the next ring will become attracted and engage the wall of the chamber 1012. The result is a step function 1210 where there is a set displacement or substantially set displacement as each of the rings engages the wall of the chamber 1012. Of course it should be noted that the electrode 1070 is not limited in terms of the number of rings and can include various numbers of rings.

FIG. 13 is a side view of an electrostatic actuator 1300, according to an example embodiment. The electrostatic actuator 1300 includes a body 1310 having a flat surface 1314, and having a chamber 1312 therein. The chamber 1312 has non-smooth walls that are covered with a fixed or first electrode 1360. The chamber 1312 includes several ridges or rings that have faces that are substantially parallel to the flat face of the bottom surface 1314. Chamber 1312 includes a first ring-shaped ridge 1313, a second ring-shaped ridge 1315 and a third ring-shaped ridge 1317. A diaphragm 1320, which includes an electrode 1370, is stretched across the opening of the chamber 1312. The diaphragm includes a mounting portion 1322 which attaches or is mounted to the flat surface 1314 of the body 1310. The diaphragm also includes a dynamic portion 1324, which is stretched across the face of the chamber. The diaphragm also includes an electrode 1370, which is sputtered on to the diaphragm 1320. The electrode 1370 is covered by an insulative material 1326, such as dielectric material. The electrode 1370 also includes a void 1372. The electrode 1370 is located on the dynamic portion 1324 of the diaphragm 1320. Therefore the electrode 1370 is also referred to as the dynamic electrode which moves along with the dynamic surface 1324 of the diaphragm 1320.

When the voltage is applied to the first or fixed electrode 1360 and also applied to the second electrode or dynamic electrode 1370, the diaphragm 1320 engages the surface of the chamber in a number of steps. As a result, the displacement versus voltage for the actuator 1300 will be very similar to the plot of the displacement versus voltage 1210 shown in FIG. 12.

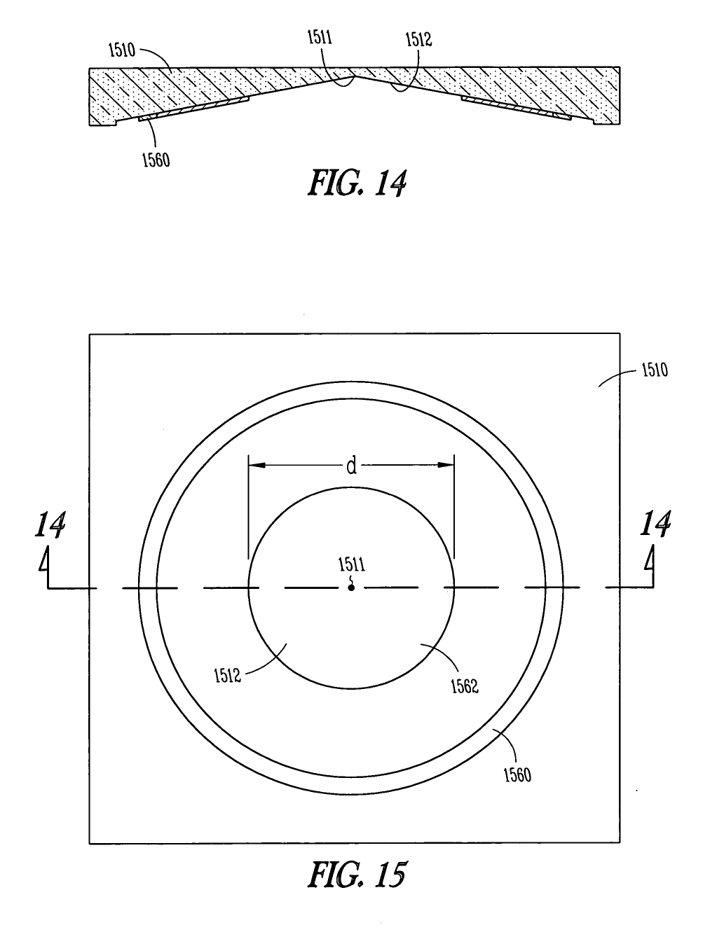

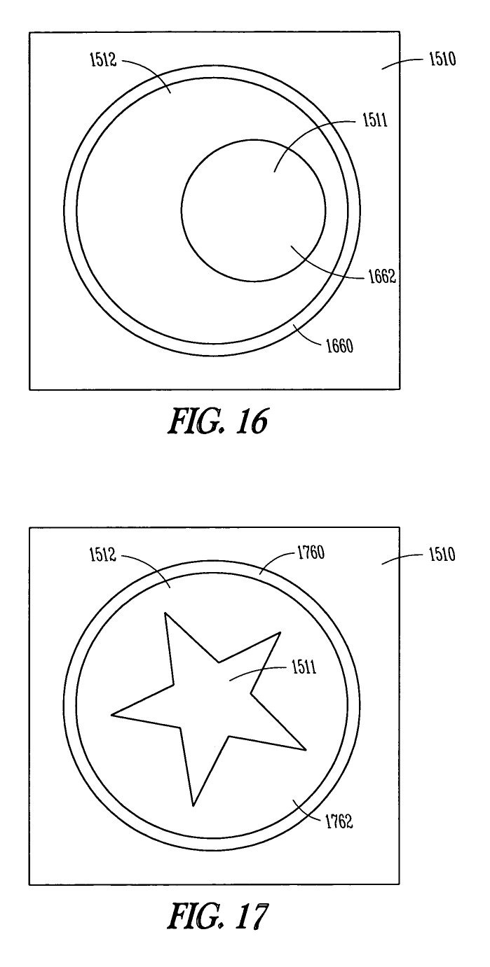

FIG. 14 is a cross-sectional view of a body 1510 that includes a conically shaped chamber 1512, according to an example embodiment. FIG. 14 also includes a first or fixed electrode 1560, which is shown generically in FIG. 14. The fixed electrode 1560 is associated with the chamber 1512 of the body 1510 can also include a void 1562, as shown in FIG. 15.

FIG. 15 is a view of a body 1510 that includes a conically shaped chamber 1512 along line 14-14 from FIG. 15, according to an example embodiment. FIG. 15 shows that the fixed electrode or first electrode 1560 has a void therein 1562. As shown in the electrode 1560 shown in FIG. 15 has a substantially circular void 1562 therein. The substantially circular void 1562 is centered about a center 1511 of the chamber 1512 of the body 1510.

FIG. 16 is a view into a conically shaped chamber, such as the conically shaped chamber 1512, of the body 1510, according to another example embodiment. FIG. 16 is another embodiment of an electrode as formed on the sidewalls of the conically shaped chamber 1512. The fixed electrode 1660 that is attached to the sidewalls of the chamber 1512 also includes a void 1662. As shown in FIG. 16, the void is circular and is offset with respect to the center 1511 of the chamber 1512.

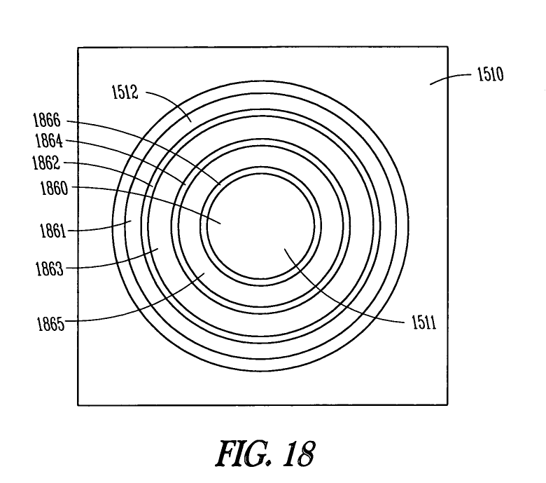

FIG. 17 is a view into a conically shaped chamber, such as the conically shaped chamber 1512, of the body 1510, according to another example embodiment. FIG. 17 is another embodiment of an electrode as formed on the sidewalls of the conically shaped chamber 1512. In this particular embodiment, the fixed or first electrode 1760 has a void 1762 therein. As shown in FIG. 17, the void 1762 is star shaped and centered about the center 1511 of the chamber 1512 of the body 1510.

FIG. 18 is a view into a conically shaped chamber, such as the conically shaped chamber 1512, of the body 1510, according to another example embodiment. FIG. 18 is another embodiment of an electrode as formed on the sidewalls of the conically shaped chamber 1512. As shown in FIG. 18, the electrode 1860 includes a number of rings 1861, 1863 and 1865. The electrode 1860 also includes a void 1862 and a void 1864 and a void 1866. In one embodiment, the rings 1861, 1863, 1865 of the electrode 1860 are all electrically connected so that when a voltage is placed on the electrode 1816, each of the rings 1861, 1863, 1865 carries the same voltage. In another embodiment, the rings 1861, 1862, 1865 of the electrode 1860 carry different voltages and therefore are not electrically connected with one another. In essence, in this particular embodiment, the ring 1861 serves and the ring 1863 and the ring 1865 all serve as separate electrodes placed upon the conical surface of the chamber 1512 of the body 1510.

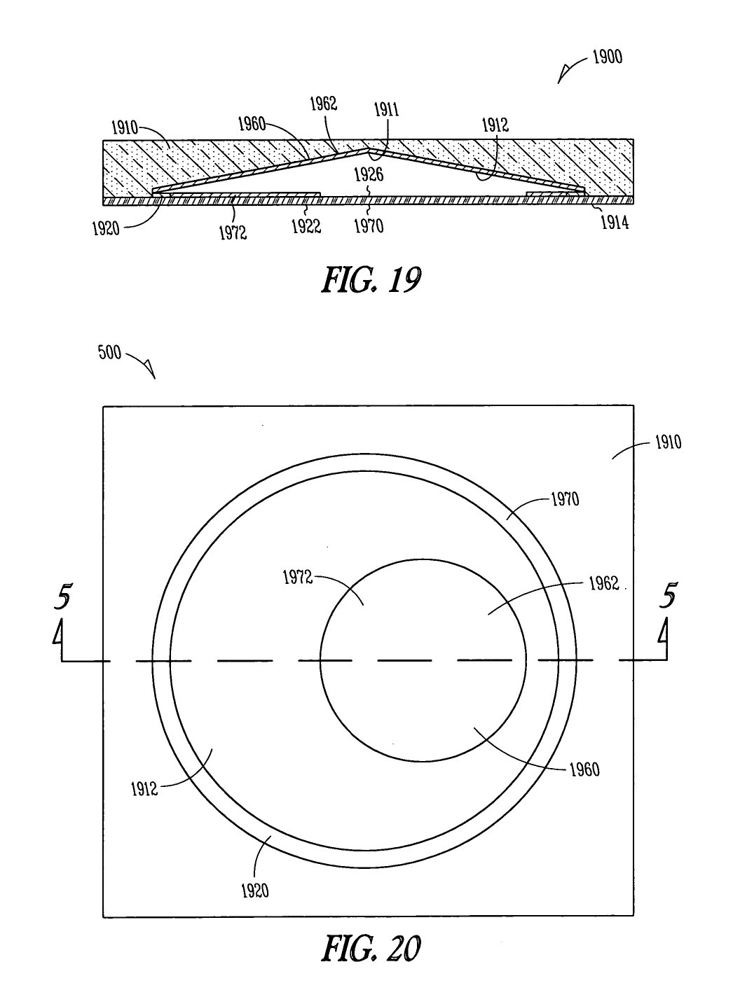

FIG. 19 is a side view of an electrostatic actuator 1900 that includes a first or fixed diaphragm 1960 and a second of dynamic electrode 1970 includes a void 1972. FIG. 20 is a view along line 20-20 from FIG. 19 of the body 1910 that includes the conically-shaped chamber 1912, according to an example embodiment. Now referring to both FIGS. 19 and 20, the details of the electrostatic actuator 1900 will be further detailed. The dynamic electrode 1970 is attached to the movable or a dynamic surface 1924 of a diaphragm 1920. The dynamic electrode is covered with an insulative material 1926, such as a dielectric. The void 1972 associated with a dynamic electrode 1970 is offset from a center 1911 of the chamber 1912 and is also offset from the center of the dynamic portion 1924 of the diaphragm 1920. The fixed or first electrode 1960 which is attached to the side walls of the chamber 1912 also includes a void 1962. The void is circular and substantially centered about the center 1911 of the chamber 1912. As shown-then, the void 1972 of the dynamic electrode 1970 is misaligned or unaligned with the void 1962 of the fixed or first electrode 1960. In other embodiments of the invention, two different patterns can be used for the fixed and the dynamic electrode. In still other example embodiments, the patterns or the voids that are produced in the fixed electrode and the dynamic electrode may be aligned. In still other embodiments, the voids in the fixed and dynamic electrodes may have different shapes. In other example embodiments, the voids in the first or fixed electrode and the second or dynamic electrode can have the same pattern and be aligned or misaligned.

Rings placed at different voltage levels can also be thought of as multiple electrodes. In other embodiments, multiple electrodes of different shapes can be placed on either the dynamic surface of the fixed surface or on both. Each of the multiple electrodes can be individually connected to external switching voltage source. The electrodes are actuated in a specific manner to digitally move the displacing element, such as a diaphragm or other displacement element. In one embodiment, the electrodes can be patterned in a wavy ring shape so that the displacing element will have overlapping regions of electrodes from different rings.

In still another embodiment, the fixed or dynamic electrode or both can be formed in a spiral-type pattern with gradual electrode removal towards center of the fixed or dynamic electrode. Again, this is similar to the above methods. The fixed and the dynamic electrodes are patterned so as to provide selected control of displacement of a dynamic element for a selected driving voltage.

An electrostatic actuator includes a body that includes a chamber. The electrostatic actuator also includes a first fixed electrode covering the chamber, and a diaphragm mounted to the body. The diaphragm also includes a mounting surface portion secured to the body, and a dynamic surface portion for movement within the chamber. A second, dynamic electrode is secured relative to the diaphragm. The second, dynamic electrode covers a portion of the dynamic surface of the diaphragm. The second, dynamic electrode includes a void therein on the dynamic surface of the diaphragm. In various embodiments, the void of the is star-shaped, ring-shaped, substantially circular, or the like. The void can be centered with respect to a center of the dynamic surface of the diaphragm or can be a center of the dynamic surface of the diaphragm. In another example embodiment, void of the second electrode can include a plurality of substantially ring-shaped portions. The electrostatic actuator can also include an insulative layer formed on the diaphragm. The second electrode is positioned between the insulative layer and the diaphragm. The electrostatic actuator also includes a voltage source in communication with the first electrode and the second electrode. The voltage source produces a voltage differential between the first electrode and the second electrode. In some embodiments, the diaphragm includes a reflective surface. The electrostatic actuator may also include an optical source, a first optical receiver, and a second optical receiver. Reflected light from the optical source is received at the first optical receiver when the diaphragm is in a first position. Reflected light from the optical source directed to the reflective surface is received at the second optical receiver when the diaphragm is in a second position.

An electrostatic actuator includes a body having a chamber therein, a first electrode secured to the chamber, and a diaphragm mounted to the body. The diaphragm includes a mounting surface portion secured to the body, and a dynamic surface portion for movement within the chamber. The electrostatic actuator also includes a second electrode secured relative to the diaphragm. In some embodiments, the first electrode includes a void therein. The void of the first electrode can have any shape such as a star-shape, a ring shape, or a substantially circular shape. The void can be centered with respect to a center of the chamber or can be offset with respect to a center of the chamber. In another example embodiment, the void of the first electrode can include a plurality of substantially ring-shaped portions. In other embodiments, the second electrode includes a void therein. In still other embodiments, both the first and the second electrode include voids therein.

An electrostatic actuator includes a body having a chamber therein, a first electrode secured to the chamber, and a diaphragm mounted to the body. The diaphragm further includes a mounting surface portion secured to the body, and a dynamic surface portion for movement within the chamber. The electrostatic actuator also includes a second electrode secured to the diaphragm. The surface of the chamber includes a non-straight wall. In one embodiment, the sidewall of the chamber includes a step. In another embodiment, the sidewall of the chamber includes a plurality of steps.

In other embodiments, the displacing or dynamic element is not limited to a diaphragm. The actuating component or dynamic electrode can also be a lever, beam, plate, or the like.

It is understood that the above description is intended to be illustrative, and not restrictive. Many other embodiments will be apparent to those of skill in the art upon reviewing the above description. The scope of the invention should be, therefore, determined with reference to the appended claims, along with the full scope of equivalents to which such claims are entitled.

What is claimed is:

1. An electrostatic actuator comprising:
a body having a chamber therein;
a first electrode covering the chamber; and
a diaphragm mounted to the body, the diaphragm further including:
a mounting surface portion secured to the body; and
a dynamic surface portion for movement within the chamber; and
a second electrode secured relative to the diaphragm, the second electrode covering a portion of the dynamic surface of the diaphragm, the second electrode including a void therein on the dynamic surface of the diaphragm.

2. The electrostatic actuator of claim 1, wherein the void of the second electrode is star-shaped.

3. The electrostatic actuator of claim 1, wherein the void of the second electrode is substantially circular.

4. The electrostatic actuator of claim 3, wherein the circular void of the second electrode is substantially concentric with a center of the dynamic surface of the diaphragm.

5. The electrostatic actuator of claim 3, wherein the circular void of the second electrode is offset from a center of the dynamic surface of the diaphragm.

6. The electrostatic actuator of claim 1, wherein the void of the second electrode is substantially ring-shaped.

7. The electrostatic actuator of claim 1, wherein the void of the second electrode includes a plurality of substantially ring-shaped portions.

8. The electrostatic actuator of claim 1 further comprising an insulative layer formed on the diaphragm, the second electrode positioned between the insulative layer and the diaphragm.

9. The electrostatic actuator of claim 1 further comprising a voltage source in communication with the first electrode and the second electrode, the voltage source producing a voltage differential between the first electrode and the second electrode

10. The electrostatic actuator of claim 1 further comprising a reflective surface formed on the diaphragm.

11. The electrostatic actuator of claim 10, further comprising:
an optical source;
a first optical receiver; and
a second optical receiver, wherein light from the optical source directed to the reflective surface is received at the first optical receiver when the diaphragm is in a first position and wherein light from the optical source directed to the reflective surface is received at the second optical receiver when the diaphragm is in a second position.

12. An electrostatic actuator comprising:
a body having a chamber therein;
a first electrode secured to the chamber; and
a diaphragm mounted to the body, the diaphragm further including:
a mounting surface portion secured to the body; and
a dynamic surface portion for movement within the chamber; and
a second electrode secured relative to the diaphragm, the first electrode including a void therein on the surface of the chamber.

13. The electrostatic actuator of claim 12, wherein the void of the first electrode is substantially circular.

14. The electrostatic actuator of claim 13, wherein the circular void of the first electrode is substantially concentric with a center of the chamber.

15. The electrostatic actuator of claim 13, wherein the circular void of the first electrode is offset from a center of the chamber.

16. The electrostatic actuator of claim 12, wherein the void of the first electrode includes a plurality of substantially ring-shaped portions.

17. The electrostatic actuator of claim 12, wherein the second electrode includes a void therein.

18. The electrostatic actuator of claim 17, wherein the void in the second electrode is offset from the void in the first electrode.

19. An electrostatic actuator comprising:
a body having a chamber therein;
a first electrode secured to the chamber; and
a diaphragm mounted to the body, the diaphragm further including:
a mounting surface portion secured to the body; and
a dynamic surface portion for movement within the chamber; and
a second electrode secured to the diaphragm, wherein the surface of the chamber includes a non-straight wall.

20. The electrostatic actuator of claim 19, wherein the sidewall of the chamber includes a step.

21. The electrostatic actuator of claim 19, wherein the sidewall of the chamber includes a plurality of steps.
